(19) United States
(12) Patent Application Publication
(10) Pub. No.: US 2003/0007360 A1
(43) Pub. Date: Jan. 9, 2003

(54) Stand lamp assembly including main and auxiliary lamp units

(76) Inventor: Duan-Cheng Hsieh, Taipei City (TW)

Correspondence Address: Ronald R. Santucci, Pitney, Hardin, Kipp & Szuch, LLP, 20th Floor, 711 Third Avenue, New York, NY, 10017, US

(21) Appl. No.: 09/899,321

(22) Filed: Jul. 5, 2001

(51) Int. Cl. F21S 8/08

(52) U.S. Cl. 362/411; 362/276; 362/410; 362/431

(57) ABSTRACT

A stand lamp assembly includes a stand frame unit, a main lamp unit, and an auxiliary lamp unit. The main and auxiliary lamp units are mounted on the stand frame unit. The auxiliary lamp unit includes a night lamp and a light sensor. The light sensor is connected to the night lamp, and controls activation of the night lamp in accordance with ambient light conditions.

### BACKGROUND OF THE INVENTION

1. Field of the Invention

The invention relates to a stand lamp assembly, more particularly to a stand lamp assembly that includes main and auxiliary lamp units.

2. Description of the Related Art

Referring to FIG. 1, the conventional stand lamp assembly 100 comprises a stand base 11, a power control circuit 12, an upright hollow stand body 13, a lamp holder 15, a lamp 16, and a lampshade 17. The stand base 11 has a weight and size sufficient to stably support the stand lamp assembly 100, and is formed as a disc-shaped body having a center hole 111 for retention of the upright stand body 13, and a side hole 112 for extension of a power cord of the control circuit 12. The stand body 13 has a lower open end 131 inserted and retained in the center hole 111 of the stand base 11, and an upper open end 133. The connection between the stand body 13 and the stand base 11 can be either threadedly or insertedly.

The lamp holder 15 is formed as an inverted cone-shaped body having a lower retaining portion 151 mounted on the upper open end 133 of the stand body 13, and a lamp socket 153 opposite to the retaining portion 151 for mounting of the lamp 16. The power control circuit 12 has a wire end 122 that extends from the stand base 11 and that passes through the stand body 13 to connect with the lamp socket 153. The power cord of the power control circuit 12 is provided with a plug member 121 for connection to an electrical outlet (not shown). A power switch 123 is connected to the wire 122 and the power cord, and is used to control activation of the lamp 16. The power switch 123 of the stand lamp assembly 100 is mounted on the stand base 11. The lampshade 17 is mounted on the lamp holder 15 to protect the lamp 16 and to enable the stand lamp assembly 100 create a mild and gentle light output.

In a circumstance where surrounding light is not sufficient, the user has to grope in the dark to locate the power switch 123 of the stand lamp assembly 100, and in the process, the user usually bumps into some objects before successfully switching on the lamp assembly 100. To avoid this drawback, some users opt to maintain the stand lamp assembly 100 alighted all the time. However, this solution results in unnecessary waste of electricity. An alternative solution is to use a night lamp (not shown) that is plugged in another electrical socket (not shown). Such night lamp alights accordingly when the surrounding light is not sufficient. Though this is a better solution, the user has to purchase the night lamp separately, and the night lamp occupies another electrical socket when in use.

### SUMMARY OF THE INVENTION

Therefore, the main object of the present invention is to provide a stand lamp assembly that includes main and auxiliary lamp units to overcome the aforementioned drawbacks of the prior art.

Accordingly, a stand lamp assembly of this invention comprises a stand frame unit, a main lamp unit, and an auxiliary lamp unit. The main and auxiliary lamp units are mounted on the stand frame unit. The auxiliary lamp unit includes a night lamp and a light sensor. The light sensor is connected to the night lamp, and controls activation of the night lamp in accordance with ambient light conditions.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional stand lamp assembly;

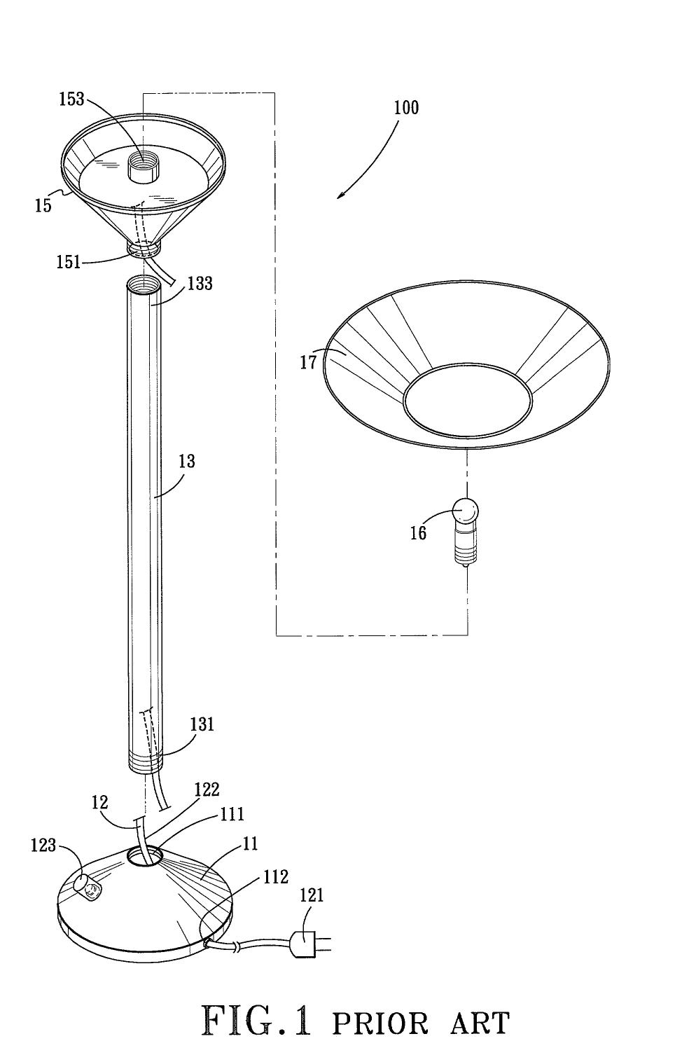

FIG. 2 is an exploded perspective view of the preferred embodiment of a stand lamp assembly according to the present invention; and

FIG. 3 is a schematic partly sectional view of the stand lamp assembly of the present invention in an assembled state.

### DETAILED DESCRIPTION OF THE PREFERRED EMBODIMENT

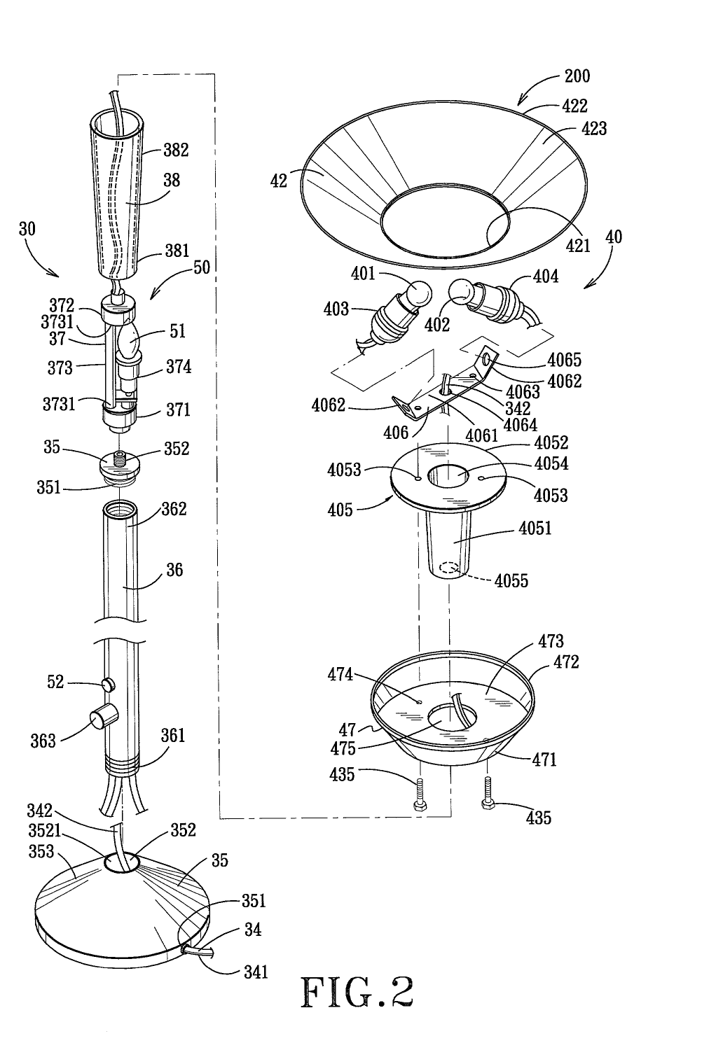

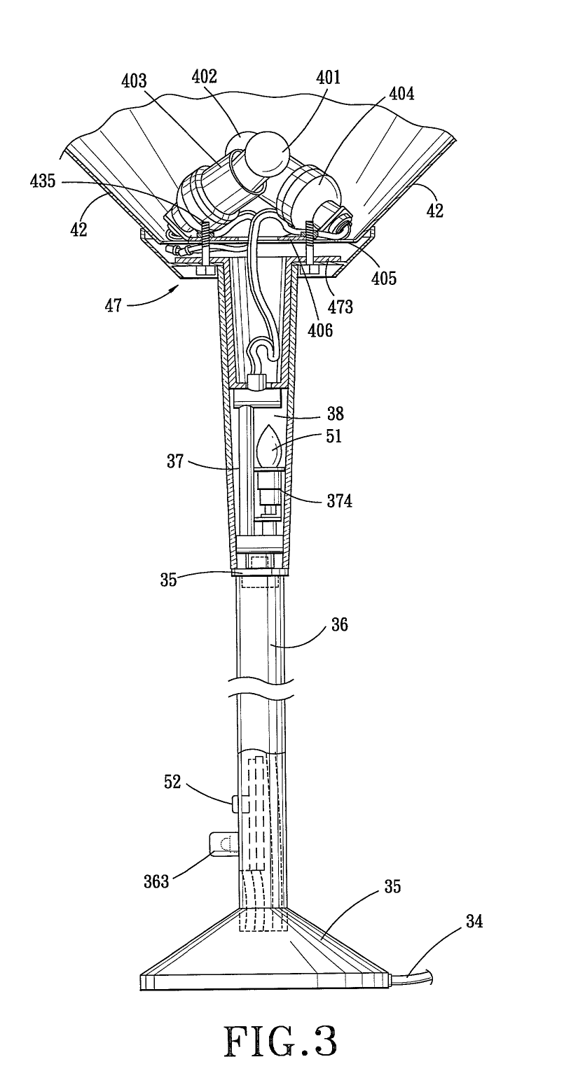

Referring to FIGS. 2 and 3, the preferred embodiment of a stand lamp assembly 200 according to the present invention is shown to comprise a stand frame unit 30, a main lamp unit 40, and an auxiliary lamp unit 50. The stand frame unit 30 includes a stand base 35, a power control circuit 34, a hollow upright stand body 36, an upright frame member 37, and a tubular sleeve 38. The stand base 35 basically has a weight and size sufficient to stably support the stand lamp assembly 200 on a ground surface, and is formed as a tapered body 353 having a center hole 352 and a side hole 351. The center hole 352 has an inner threaded wall 3521.

The power control circuit 34 includes a power cord 341 and a wire unit 342 that extend outwardly from the stand base 35. The power cord 341 extends outwardly from the side hole 351 and is terminated by a plug member for connection to an electrical outlet (not shown). The wire unit 342 extends outwardly from the center hole 352 to connect with the lamp units 401, 402.

The hollow upright stand body 36 has a uniform thickness, an externally threaded lower portion 361, and an upper portion 362 with inner threaded wall opposite to the lower portion 361. The lower portion 361 is engaged threadedly to the inner threaded wall 3521 of the center hole 352, thereby securing the stand body 36 on the stand base 35. A power switch 363 is connected to the control circuit 34 in an known manner, and controls the activation of the main lamp unit 40. In this embodiment, the power switch 363 is mounted on the upright stand body 36.

The upright frame member 37 has lower and upper sections 371, 372, and left and right sides 373, 374. The lower section 371 has an inner threaded hole, and engages the upper portion 362 of the upright stand body 36 by means of a connector 35. The connector 35 has an externally threaded upper end 352 that threadedly engages the lower section 371 of the upright frame member 37, and an externally threaded lower end 351 opposite to the upper end 352 and threadedly engaging the upper portion 362 of the stand base 36, thereby securing the upright frame member 37 on the upright stand body 36. The left side 373 is formed with a hollow post having end holes 3731 that communicate with the lower and upper sections 371, 372. The right side 374 is formed with a night lamp socket. The wire unit 342 extends through the left side 373.

The tubular sleeve 38 is made of a light transmissive material, is sleeved on the upright frame member 37, and has lower and upper ends 381, 382. The lower end 381 is seated on the connector 35 at the upper portion 362 of the upright stand body 36. The upper end 382 is mounted with the main lamp unit 40.

The main lamp unit 40 includes a pair of main lamps 401, 402, a pair of main lamp sockets 403, 404, a positioning seat 405, and a lamp socket holder 406. Each of the main lamps 401, 402 is mounted on a respective one of the main lamp sockets 403, 404. The positioning seat 405 is formed with an upper plate portion 4052 and a retaining post portion 4051. The upper plate portion 4052 has a center through-hole 4054 and two diametrically opposed holes 4053, and is seated on the upper end 382 of the tubular sleeve 38. The retaining post portion 4051 extends downwardly from the upper plate portion 4052, has a through-hole 4055 for extension of the wire unit 342 therethrough, and is insertingly retained in the tubular sleeve 38. The lamp socket holder 406 is mounted on the upper plate portion 4052 of the positioning seat 405, and has an elongated portion 4061 and two anchoring end portions 4062. The elongated portion 4061 has a center through-hole 4064 for extension of the wire unit 342 therethrough, and two diametrically opposed holes 4063 that correspond to the holes 4053 in the positioning seat 405. The wire unit 342 is connected to the main lamp sockets 403, 404. Each of the anchoring end portions 4062 is formed with a retaining hole 4065 for retention of a respective one of the main lamp sockets 403, 404.

The auxiliary lamp unit 50 is mounted on the stand frame unit 30, and includes a night lamp 51 and a light sensor 52. The night lamp 51 is mounted on the lamp socket 374 of the frame member 37. The light sensor 52 is connected to the night lamp 51 and to the power control circuit 34, and controls activation of the night lamp 51 in accordance with ambient light conditions. The light sensor 52 in this embodiment is a light sensitive resistor.

The stand lamp assembly 200 further comprises a lampshade 42 and an annular skirt member 47. The lampshade 42 has a lower edge 421, an upper edge 422 and a surrounding wall 423 between the lower and upper edges 421, 422. The lower edge 421 is seated on the upper plate portion 4052 of the positioning seat 405. The surrounding wall 423 is disposed to surround the lamp socket holder 406, thereby surrounding the main lamps 401, 402. The annular skirt member 47 is disposed to surround the upper plate portion 4052 of the positioning seat 405, has a bottom edge portion 471, a top edge portion 472 opposite to the bottom edge portion 471, and an inward flange 473 between the bottom and top edge portions 471, 472. The top edge portion 472 engages the surrounding wall 423 of the lampshade 42. The inward flange 473 has two diametrically opposed holes 474 that correspond to the through-holes 4053 of the upper plate portion 4052 of the positioning seat 405 and the through-holes 4063 of the lamp socket holder 406, and a center hole 475 for extension of the retaining post portion 4051 of the positioning seat 405 therethrough. The lamp socket holder 406 and the upper plate portion 4052 of the positioning seat 405 are fastened to the inward flange 473 by means of screws 435.

In use, after connecting the power control circuit 34 to a power source (not shown), the power switch 363 is operated to switch on the main lamps 401, 402. To turn off the main lamps 401, 402, the power switch 363 is simply operated to an off position. The light sensor 52 will not allow electrical current to flow through and activate the night lamp 51 in the event of strong surrounding light. However, as soon as the room darkens, the light sensor 52 will activate the night lamp 51 accordingly. As such, there is no need for the user to grope in the dark so as to locate the power switch 363 of the stand lamp assembly 200 when the room is dark.

While the present invention has been described in connection with what is considered the most practical and preferred embodiment, it is understood that this invention is not limited to the disclosed embodiments but is intended to cover various arrangements included within the spirit and scope of the broadest interpretation so as to encompass all such modifications and equivalent arrangements.

I claim:

1. A stand lamp assembly comprising:
a stand frame unit;
a main lamp unit mounted on said stand frame unit; and
an auxiliary lamp unit mounted on said stand frame unit, said auxiliary lamp unit including a night lamp and a light sensor connected to said night lamp, said light sensor controlling activation of said night lamp in accordance with ambient light conditions.

2. The stand lamp assembly of claim 1, wherein said light sensor is a light sensitive resistor.

3. The stand lamp assembly of claim 1, further comprising a power switch mounted on said stand frame unit and connected to said main lamp unit to control activation of said main lamp unit.

4. The stand lamp assembly of claim 1, wherein said stand frame unit includes:
a stand base;
an upright stand body having a lower portion mounted on said stand base, and an upper portion opposite to said lower portion;
an upright frame member mounted on said upper portion of said stand body, and provided with a night lamp socket for mounting said night lamp thereon, said night lamp socket interconnecting said night lamp and said light sensor; and
a tubular sleeve made of a light transmissive material, said tubular sleeve being sleeved on said upright frame member and having a lower end seated on said upper portion of said upright stand body, and an upper end mounted with said main lamp unit.

5. The stand lamp assembly of claim 4, wherein said main lamp unit includes:
a main lamp;
a main lamp socket for mounting said main lamp thereon;
a positioning seat formed with an upper plate portion seated on said upper end of said tubular sleeve, and a retaining post portion extending downwardly from said upper plate portion and insertingly retained in said tubular sleeve; and
a lamp socket holder mounted on said upper plate portion of said positioning seat and having said main lamp socket retained thereon.

6. The stand lamp assembly of claim 5, further comprising a power switch mounted on said upright stand body and connected to said main lamp socket to control activation of said main lamp.

7. The stand lamp assembly of claim 5, further comprising a lampshade having a lower edge, an upper edge and a surrounding wall between said lower and upper edges, said lower edge being seated on said upper plate portion of said positioning seat, said surrounding wall being disposed to surround said lamp socket holder to thereby surround said main lamp.

8. The stand lamp assembly of claim 7, further comprising an annular skirt member disposed to surround said upper plate portion of said positioning seat, said skirt member having a top edge portion engaging said surrounding wall of said lampshade, said skirt member further having an inward flange fastened to said upper plate portion of said positioning seat.
